(19) United States
(12) Patent Application Publication
(10) Pub. No.: US 2008/0085030 A1
(43) Pub. Date: Apr. 10, 2008

(54) INCONSPICUOUS COMMUNICATIONS ASSEMBLY

(75) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(73) Assignee: SureFire, LLC

(21) Appl. No.: 11/869,931

(22) Filed: Oct. 10, 2007

Related U.S. Application Data
(63) Continuation-in-part of application No. 11/411,314, filed on Apr. 26, 2006.
(63) Continuation-in-part of application No. 11/869,526, filed on Oct. 9, 2007.

(51) Int. Cl. H04R 25/00; H04B 1/38

(52) U.S. Cl. 381/380; 455/90.2

(57) ABSTRACT

A communications assembly comprising thin acoustic tubing and an ear insert or an earpiece/extension is disclosed. The ear insert can comprise a reusable foam ear insert. The earpiece can be configured to be captured within a wearer's conchae. The extension can be attached to the earpiece and can be configured to be inserted into the wearer's ear canal. The thin acoustic tube can be configured to communicate sound to the ear insert or earpiece/extension. The use of thin acoustic tubing in combination with an unobtrusive ear insert or earpiece/extension provides an inconspicuous communications assembly that is suited for use in covert operations.

### PRIORITY CLAIM

This patent application is a continuation-in-part (CIP) patent application of U.S. Ser. No. 11/411,314, filed Apr. 26, 2006, and entitled EARPIECE WITH EXTENSION (M-15744-1P US), and is also a continuation-in-part (CIP) patent application of U.S. Ser. No. 11/869,526, filed Oct. 9, 2007, and entitled REUSABLE FOAM EAR INSERT (M-16946 US), the entire contents of both of which are hereby expressly incorporated by reference.

### TECHNICAL FIELD

The present invention relates generally to acoustics. The present invention relates more particularly to an inconspicuous communications assembly wherein sound is provided to an earpiece via non-obtrusive, small diameter acoustic tubing.

### BACKGROUND

Communications assemblies for use with two-way radios are well known. Such communications assemblies comprise a speaker that receives an electrical signal from a two-way radio via a cable therebetween. The electrical signal is converted into sound by the speaker and the sound is communicated to an earpiece by acoustic tubing.

Two-way radios are frequently used by soldiers, police, and fire personnel. In such instances, there may be little concern about how conspicuous the communications assembly is. However, such two-way radios are also used by the Secret Service, undercover police officers, and other covert personal. In these instances, it is generally undesirable that the communications assembly be easily noticed. Indeed, observation of the communications assembly can sometimes jeopardize an operation and possibly even the safety of the operatives.

Communications assemblies can be noticed either visually or aurally. Communications assembly can be noticed visually when they are large, bulky, have easily recognized shapes, or are colored so as to stand out with respect to the wearer's skin color.

Communications assembly can be noticed aurally when the volume thereof is loud enough to be overheard by someone other than the wearer. According to contemporary practice, the volume of a two-way radio may have to be set to a level such that it can be overhear by someone other than the wearer in some instances. For example, the volume may have to be set to such an undesirably high level when ambient noise is high, when radio transmission are less intelligible, and when the wearer is hearing impaired.

In such instances, setting the volume to a higher level can make the radio communications easier for the wearer to hear and understand. However, it also makes the radio communications easier for others to hear.

As such, it is desirable to provide an inconspicuous communications assembly wherein the acoustic tubing and the earpiece thereof are less obtrusive that those of contemporary devices. It is also desirable to provide an inconspicuous communications assembly wherein radio communications can be more readily heard and understood by the wearer such that lower a radio volume can be use, thus mitigating the likelihood that the radio communication will be overheard.

### BRIEF SUMMARY

According to an embodiment, a communications assembly for use in covert operations and the like can comprise an earpiece configured to be captured within a wearer's conchae, an extension attached to the earpiece and configured to be inserted into the wearer's ear canal, and a thin acoustic tube configured to communicate sound to the earpiece. Either a speaker or an amplifier/speaker combination can be attached to the acoustic tube so as to effect the communication sound through the thin acoustic tube to the earpiece and extension.

According to an embodiment, a communications assembly for use in covert operations and the like can comprise an ear insert configured to be inserted into the wearer's ear canal and a thin acoustic tube configured to communicate sound to the ear insert. The ear insert can comprise a reusable foam ear insert.

As used herein, the term “extension” can be defined to include a structure that extends from an earpiece and is inserted, at least partially, into the ear canal. Thus, an extension is used in combination with an earpiece. An “earpiece” can be defined as a structure that is held in place by one or more structures of the external ear, such as the conchae. An earpiece can be used to hold an extension within the ear canal. An “ear insert” can be defined to include a structure that is inserted into the ear canal and that is not associated with an earpiece. That is, an ear insert can hold itself within the ear canal. In some instances, the distinction between an extension and an ear insert can be insubstantial and the two terms can be used interchangeably.

According to an embodiment, a communications assembly can comprise an ear insert configured to be inserted into the wearer's ear canal. A thin acoustic tube can pass completely through the ear insert so as to provide a generally continuous lumen from a speaker to a point proximate an eardrum.

According to an embodiment, a communications assembly can comprise an earpiece configured to be captured within a wearer's conchae and an extension attached to the earpiece and configured to be inserted into the wearer's ear canal. A thin acoustic tube can pass completely through the extension so as to provide a generally continuous lumen from a speaker to a point proximate an eardrum.

According to an embodiment, a two-way radio system can comprise a two way radio, a speaker in electrical communication with the two-way radio, a thin acoustic tube in acoustic communication with the speaker, an earpiece to which the acoustic tube is attached, and an extension attached to the earpiece and configured to be inserted into the wearer's ear canal.

According to an embodiment, a two-way radio system can comprise a two-way radio, a speaker in electrical communication with the two-way radio, a thin acoustic tube configured to communicate sound from the speaker to the earpiece, and an ear insert configured to be inserted into the wearer's ear canal. The ear insert can be in acoustic communication with the thin acoustic tubing.

Thus, a communications assembly that is better suited for use in covert operation, wherein detection thereof is undesirable, is provided. This invention will be more fully understood in conjunction with the following detailed description taken together with the following drawings.

### BRIEF DESCRIPTION OF THE DRAWINGS

FIG. 1 is a side view of an ear having an ear insert worn within the ear canal, wherein the ear insert has a thin acoustic tube extending therefrom according to an example of an embodiment;

FIG. 2 is a side view of the acoustic tube of FIG. 1;

FIG. 3 is a front view of the acoustic tube of FIG. 1;

FIG. 4 is a side view of the acoustic tube of FIGS. 2 and 3, having a microphone, sound amplifying circuitry, and speaker attached thereto, according to an example of an embodiment;

FIG. 5 is a side view of the acoustic tube of FIGS. 2 and 3, having a speaker attached thereto, according to an example of an embodiment;

FIG. 6 is a side view of the acoustic tube of FIGS. 2 and 3, having a reusable foam ear insert attached thereto according to an example of an embodiment;

FIG. 7 is a front view of the acoustic tube and foam ear insert of FIG. 6;

FIG. 8 is a perspective view of the reusable foam insert of FIGS. 6 and 7;

FIG. 9 is a cross-sectional side view of the reusable foam insert of FIGS. 6-8;

FIG. 10 is a side view of an earpiece with an extension, having a thin acoustic tube extending therefrom according to an example of an embodiment;

FIG. 11 is a front view of the earpiece of FIG. 10;

FIG. 12 is a perspective view of an earpiece having a flanged extension according to an example of an embodiment;

FIG. 13 is a perspective view of the extension of the earpiece of FIG. 12 wherein the extension is removed from the earpiece;

FIG. 14 is a perspective view of an embodiment of the extension of FIG. 13, wherein openings are formed in the flanges thereof;

FIG. 15 is a perspective view of an embodiment of the extension of FIG. 13, wherein openings are formed in the stem thereof;

FIG. 16 is a perspective view of the extension of FIG. 13, showing a Hoch's filter inserted therein;

FIG. 17 is a side view of the earpiece of FIG. 12, wherein the extension is removed therefrom;

FIG. 18 is a bottom view of the earpiece of FIG. 17, showing the aperture therein with dashed lines;

FIG. 19 is a perspective view of an earpiece having a flanged extension according to an example of an embodiment;

FIG. 20 is a perspective view of the extension of the earpiece of FIG. 19 wherein the extension is removed from the earpiece;

FIG. 21 is a perspective view of the earpiece of FIG. 12 having thin acoustic tubing attached thereto;

FIG. 22 is a perspective view of the flanged extension of FIG. 12, showing the Hoch filter exploded therefrom and also showing a flexible skin (dashed lines) formed partially thereover;

FIG. 23 is a perspective view of a flanged extension having three flanges, according to an example of an embodiment;

FIG. 24 is a perspective view of a flanged extension having four flanges, according to an example of an embodiment;

FIG. 25 is a perspective view of a foam, fiber, or fabric extension, according to an example of an embodiment;

FIG. 26 is a side view of a foam, fiber, or fabric extension having a sound transmissive bore formed therethrough according to an embodiment, the bore being shown in dashed lines;

FIG. 27 is a side view of a tapered foam, fiber, or fabric extension, according to an example of an embodiment;

FIG. 28 is a side view of an extension that is not inserted substantially into the ear canal, according to an example of an embodiment; and

FIG. 29 is a perspective view of a two-way radio system, according to an example of an embodiment.

Embodiments of the present invention and their advantages are best understood by referring to the detailed description that follows. It should be appreciated that like reference numerals are used to identify like elements illustrated in one or more of the figures.

### DETAILED DESCRIPTION

A method and system for facilitating covert radio communications and the like are disclosed. According to an example of an embodiment, a thin acoustic tube facilitates communication of sound from a speaker to an ear insert or earpiece extension that is at least partially within the wearer's ear canal.

According to contemporary practice, acoustic tubing having an outer diameter of approximately 3 mm and an inner diameter of approximately 1.5 mm facilitates the communication of sound from a speaker to the wearer's ear. However, such contemporary acoustic is substantially conspicuous and obtrusive. That is, it is comparatively easy to notice. Having the acoustic tubing noticed can jeopardize covert operations and endanger a covert operative's safety.

Thin acoustic tubing is substantially less conspicuous and obtrusive. It is therefore substantially less likely to be noticed during covert operations. Thin acoustic tubing can be defined herein as tubing having an outer diameter of approximately 0.8 mm to approximately 1.4 mm. Thin acoustic tubing can have an inner diameter of approximately 0.4 mm to approximately 0.8 mm. For example, thin acoustic tubing can have an outer diameter of approximately 1.0 mm and an inner diameter of approximately 0.5 mm. Thin acoustic tubing can be clear, flesh colored (colored to match the color of the skin of the wearer), of any other color that tends to make the tubing less likely to be noticed when worn.

Thin acoustic tubing can be more comfortable to wear, as compared to conventional acoustic tubing. Thin acoustic tubing is lighter and therefore less noticeable to the wearer than conventional acoustic tubing. The smaller outer diameter of thin acoustic tubing allows it to pass over the ear (between the top of the ear and the head) more easily.

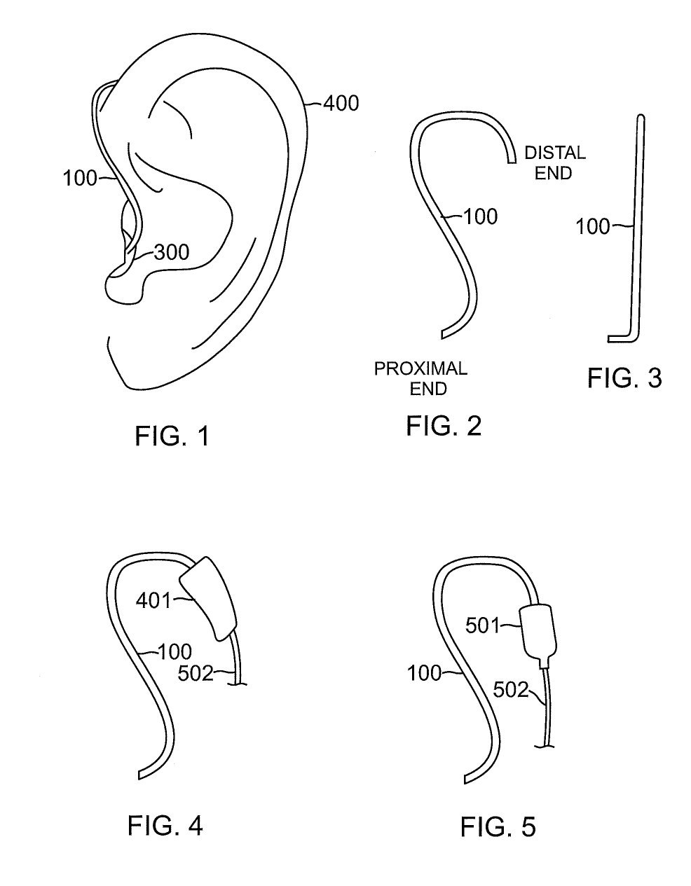

Referring now to FIG. 1, a foam ear insert 300 is inserted within the ear canal of a wearer's ear 400. The foam insert 300 can have a covering so as to define a reusable foam ear insert. Such a reusable foam insert is described in detail with respect to FIGS. 8 and 9 below.

A thin acoustic tube 100 extends from the foam insert 300 and passes over the top of the ear 400. The thin acoustic tube 100 facilitates the communication of sound from a speaker to the foam insert 300. The thin acoustic tube 100 can attach to a speaker and amplifier, which can be behind the ear 400. The speaker and amplifier can be used to enhance ambient sound. Either alternatively or additionally, the thin acoustic tube 100 can attach to just a speaker, which can be behind the ear 400. The speaker can be part of a two-way radio system. Thus, the inconspicuous communications assembly can be used to facilitate enhanced listening to ambient sound and/or to facilitate listening to a sound producing device such as a two-way radio or cellular telephone.

The use of thin acoustic tube 100 in combination with a foam ear insert 300 provides an inconspicuous and unobtrusive communications assembly. The likelihood of undesirable detection of the communications assembly can be further mitigated by coloring the thin acoustic tube 100 and the covering of the foam ear insert 300 so as to match the color of the wearer's skin.

Referring now to FIGS. 2 and 3, the thin acoustic tube 100 can be generally shaped somewhat like the letter “S”. In this manner, routing over the ear and to the ear canal is readily facilitated. As shown in FIG. 3, there can be a sharp, e.g., approximately right angle, bend near the bottom of the thin acoustic tube 100 so as to position the proximal end thereof for connection to the ear insert 300.

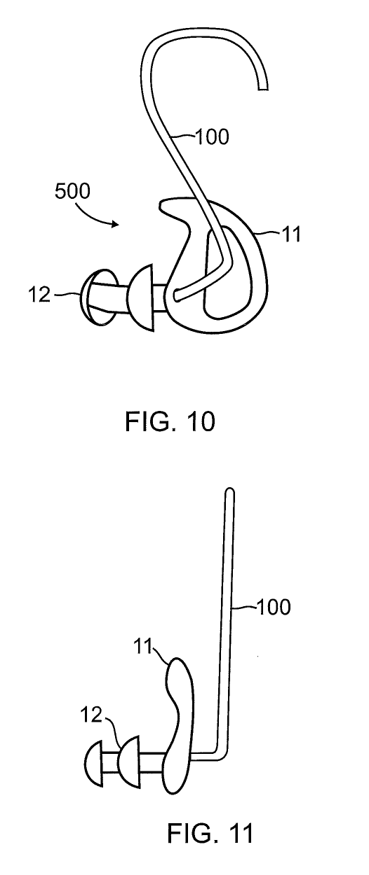

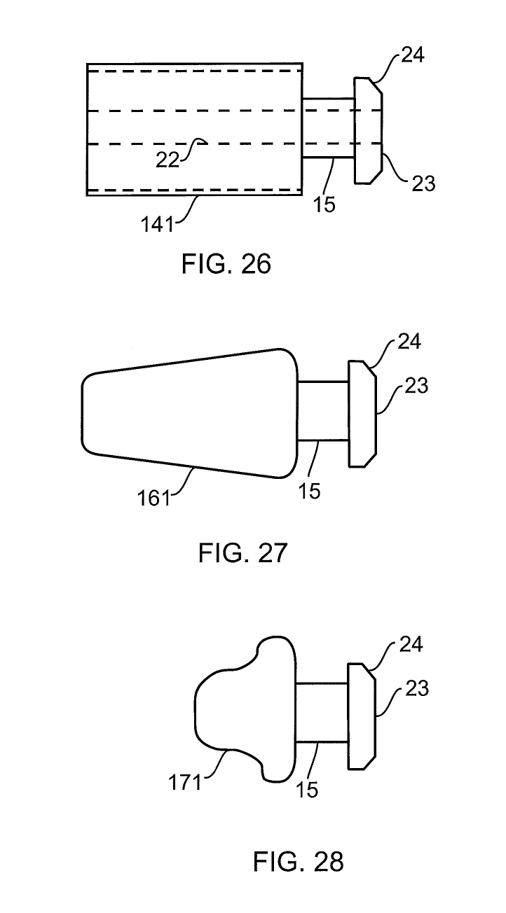

Referring now to FIG. 4, a microphone, amplifier, and speaker assembly 401 can pick upon ambient sound, amplify the ambient sound electronically, and provide the amplified ambient sound to an ear insert such as foam ear insert 300 of FIGS. 1 and 6-9 or to an earpiece and/or extension such as those of FIGS. 10-29. Thus, the microphone and amplifier assembly 401 can be attached to the distal end of thin acoustic tube 100 and an insert, earpiece and/or extension can be attached to the proximal end thereof. The speaker of the microphone and amplifier assembly 401 can also be provided a signal from a device such as a cellular telephone or two-way radio.

The use of such a microphone and amplifier assembly can be particularly advantageous in covert operations wherein it is desirable to hear ambient sound, such as voices. It facilitates listening to ambient sound while also listening to a two-way radio.

Referring now to FIG. 5, a speaker 501 can be attached to the distal end of thin acoustic tube 100. A cable 502 can provide electrical communication from a two-way radio to speaker 501. Alternatively, cable 502 can provide electrical communication from a radio receiver, a cellular telephone, a music player (such as an MP3 player or an iPod), or the like.

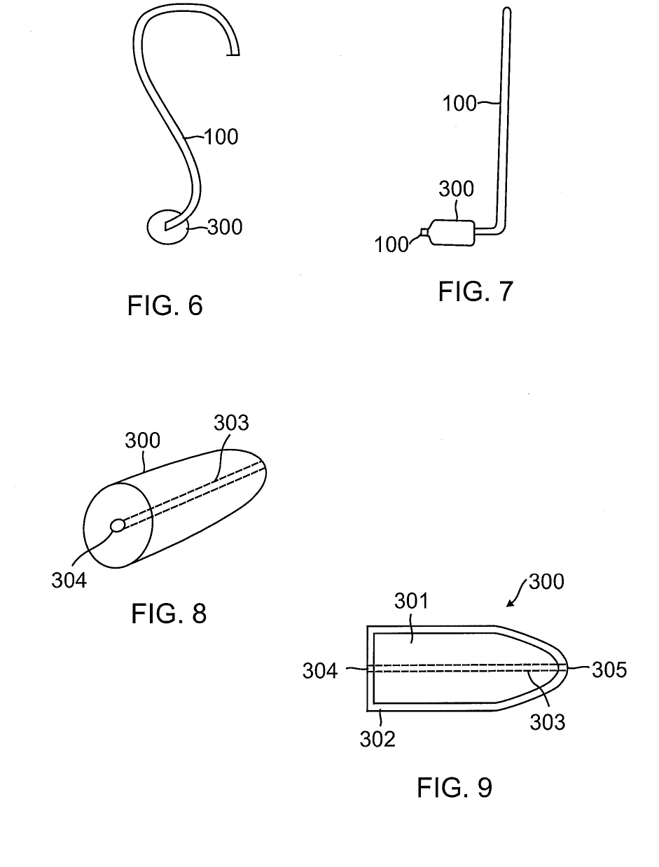

Referring now to FIGS. 6 and 7, a foam ear insert 300 can be attached to the proximal end of thin acoustic tube 100. The foam ear insert 300 substantially blocks ambient sound while communicating sound from a speaker (such as 501 of FIG. 5) through the ear canal.

With particular reference to FIG. 7, the thin acoustic tube 100 can pass almost through or entirely through the foam ear insert 300. Thus, the proximal end of thin acoustic tube 100 can be flush with or extend from the foam ear insert 300. In this manner, the proximal end of acoustic tube 100 can be placed proximate the eardrum so as to achieve the benefits discussed in detail below.

Referring now to FIGS. 8 and 9, an exemplary reusable foam ear insert 300 can comprise a foam body 301 having a covering 302 formed thereover and having a bore 303 formed generally centrally and longitudinally therethrough. The bore can be formed concentrically with respect to the central axis of the body 301 or can be formed at an angle, offset, or eccentrically with respect thereto. The bore 303 can have an outer (generally disposed outside of the ear) opening 304 and an inner (generally disposed inside of the ear) opening 305. The bore 304 facilitates the communication of sound through the ear canal.

The bore 303 can comprise an opening formed through the body 301. Optionally, the bore 303 can comprise a tube disposed within the opening. The tube can be substantially more rigid than the foam of the body 301. For example, the body 301 can comprise foam rubber and the tube can comprise more solid rubber. Such use of a tube can inhibit the undesirable collapse of the bore 303 when the ear insert is disposed within the ear canal.

An example of such a reusable foam ear insert is disclosed in U.S. patent application Ser. No. 11/869,526, filed on Oct. 9, 2007, and entitled REUSABLE FOAM EAR INSERT, the entire contents of which are hereby expressly incorporated by reference.

Thus, a covert communications system may comprise, for example, a two-way radio that is worn beneath the clothing, an electrical cable 502 that extends from the two way radio to the speaker 501, and a thin acoustic tube 100 that extends from the speaker 501 to a foam ear insert 300, as discussed in further detail below. A cellular telephone can be used instead of a two-way radio.

Referring now to FIGS. 10 and 11, an earpiece with a flanged extension 500 is attached at the proximal end of thin acoustic tube 100. The earpiece with flanged extension 500 can comprise an earpiece 11 having a flanged extension 12 attached thereto. The earpiece 11 can be configured to be captured within the conchae of a wearer's ear. The flanged extension 12 can be configured to be inserted into a wearer's ear canal.

Examples of such earpiece extensions are disclosed in U.S. Ser. No. 11/411,314, filed Apr. 26, 2006, and entitled EARPIECE WITH EXTENSION (M-15744-1P US), the entire contents of which are hereby expressly incorporated by reference.

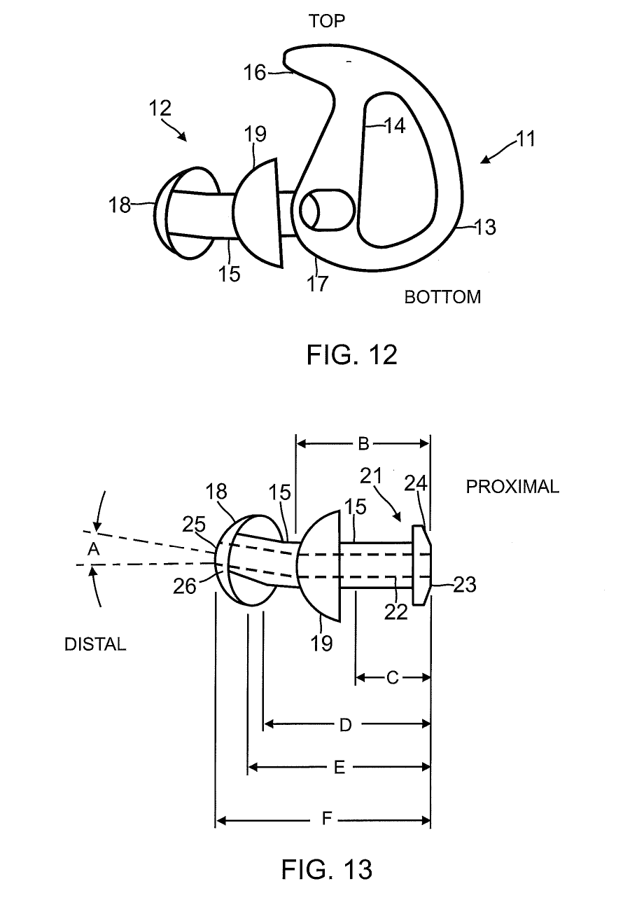

Referring now to FIGS. 12, 13, 17, and 18, an example of an embodiment of an earpiece 11 is provided. An example of an extension 12 which can be attached to the earpiece 11 is also shown.

Earpiece 11 can comprise a generally arcuate rib 13 that has upper and lower ends. Arcuate rib 13 can be attached to a straight rib 14 at the upper and lower ends of arcuate rib 13. An upper lobe 16 can be formed proximate where arcuate rib 13 and straight rib 14 join at the top of earpiece 11. Similarly, a lower lobe 17 can be formed proximate where arcuate rib 13 and straight rib 14 join at the bottom of earpiece 11.

Earpiece 11 can be configured to be disposed and held in place within the conchae of a human ear. More particularly, the crus and the antihelix of a wearer's ear can cooperate to capture upper lobe 16 and the tragus and antitragus can cooperate to capture lower lobe 17. The antihelix and the antitragus can cooperate to capture arcuate rib 13. Thus, earpiece 11 can be configured to be captured by protrusions of the conchae. In this manner, earpiece 11 can be held firmly in place within the conchae and can therefore maintain extension 12 in a desired position within the ear canal.

Extension 12 can be either removably or permanently attached to earpiece 11. Extension 12 can be removably attached to earpiece 11 by friction fit, by detents, by threads, or by any other desired means. For example, extension 12 can be friction fit to earpiece 11 by sizing a proximal portion 21 (FIG. 2) of extension 12 so as fit tightly within an aperture 61 (FIG. 6) of earpiece 11.

Extension 12 can be permanently attached to earpiece 11 by adhesive bonding, ultrasonic welding, or by any other desired means. Alternatively, extension 12 can be integrally formed to earpiece 11, such as by injection molding earpiece 11 and extension 12 within a common mold cavity. Thus, earpiece 11 and extension 12 can be formed either integrally or separately.

Earpiece 11 and extension 12 can be formed of a soft, resilient material to enhance comfort during use. Both earpiece 11 and extension 12 can be formed of the same material. For example, earpiece 11 and extension 12 can be formed of a resilient polymer, such as silicon rubber. Earpiece 11 and extension 12 can be formed of a material having a Shore A durometer of between 35 and 45, such as a Shore A durometer of approximately 40.

Earpiece 11 can function as a stop to prevent extension 12 from being inserted too far into the ear. Earpiece 11 can also prevent extension 12 from being inadvertently removed or loosened from the ear. The length of extension 12 determines, at least in part, how close the tip thereof is positioned with respect to the eardrum.

With particular reference to FIG. 13, according to one embodiment extension 12 comprises a stem 15 and two flanges, 18 and 19. Extension 12 can comprise any desired number of flanges, including no flanges at all. Stem 15 can be hollow (so as to substantially transmit sound). Stem 15 can also be partially hollow (so as to selectively transmit sound). For example, stem 15 can comprise portions of reduced diameter, baffles, and/or filters (such as a Hochs filter), in order to modify the transmission of sound therethrough. Thus, the transmission of some frequencies, e.g., undesirable frequencies such as those associated with loud, distracting, or annoying sounds, can be mitigated.

Stem 15 can bend such that it angles upwardly to conform to the upward angle of the human ear canal. For example, stem 15 can bend such that it angles upwardly at an angle, Angle A, of approximately 30°. The distance between the proximal end of extension 12 and the distal end of outer flange 19, Dimension B, can be approximately 0.545 inch. The distance between the proximal end of extension 12 and the point where a filter (such as a Hoch filter) ends, Dimension C, can be approximately 0.304 inch. The distance between the proximal end of extension 12 and the bend in stem 15, Dimension D, can be approximately 0.680 inch. The distance between the proximal end of extension 12 and a distal end of inner flange 18, Dimension E, can be approximately 0.743 inch. The distance between the proximal end of extension 12 and the distal end of inner flange 18, Dimension F, can be approximately 0.870 inch.

The diameter of stem 15 can be approximately 0.189 inch. Stem 15 can optionally have a bore 22 formed therethrough. Bore 22 can have a diameter of approximately 0.094 inch. Outer flange 19 can have a radius of approximately 0.241 inch. Similarly, inner flange 18 can have a radius of approximately 0.193 inch. Thus, the radius of inner flange 18 can be substantially less than the radius of outer flange 19, so as to better accommodate the manner in which the human ear canal becomes narrower as it gets deeper.

The exemplary angle and dimensions discussed above provide a single extension that is suitable for use with a large number individuals. Those skilled in the art will appreciate that other dimensions are likewise suitable.

The distal end of bore 22 defines a sound output port 26 (FIGS. 13 and 20). Extension 12 is configured such that sound output port 26 is positioned proximate the wearer's eardrum. That is, extension 12 can be configured so as to position a distal end 25 thereof proximate the eardrum. In this manner, sound transmitted through bore 22 (such as sound from a two-way radio), is brought close to the eardrum such that the volume of the sound required can be substantially reduced. For example, the extension can position sound output port 26 within one, two, or three millimeters of the eardrum. The extension can have a length of approximately ½ inch. The extension can have a length of ⅝ inch or more.

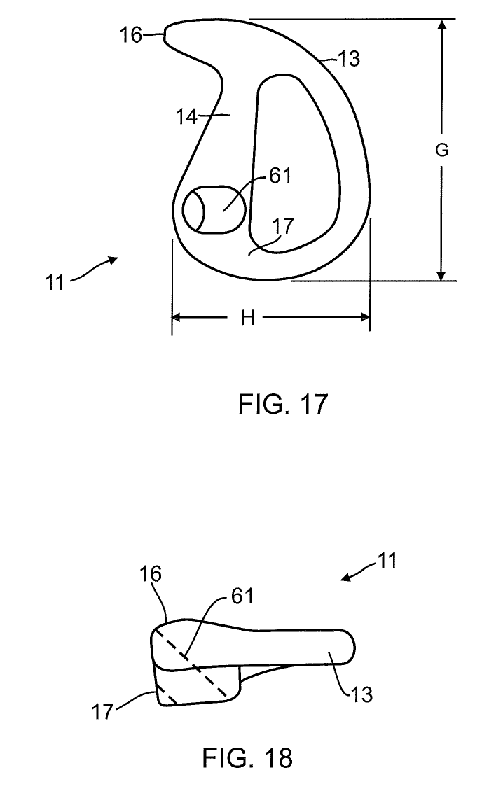

A head 23 can be formed upon the proximal end of stem 15 so as to enhance friction with respect to aperture 61 (FIG. 17) of earpiece 11 and/or so as to define detents that tend to keep extension 12 attached to earpiece 11. Bevels 24 can optionally be formed upon head 23 to better facilitate insertion of head 23 through aperture 61.

The extension may comprise a flanged extension, having flanges as shown in FIGS. 10-16 and 19-24. The flanges generally fill (close off) the ear canal and tend to block ambient sound. Although sometimes it is desirable to block ambient sound, other times, it is desirable for the user to hear ambient sound. Thus, the flanges can have one or more openings formed therein, as discussed below. Although two flanges are shown, the extension may comprise more or less flanges. For example, the extension may comprise three, four, five, six, or more flanges. The flanges need not be identical, but rather may vary in size, shape, orientation and/or positions of attachment to the stem, for example.

The extension can have a bore formed completely therethrough (along its entire length) to facilitate the transmission of sound from a speaker (such as via acoustic tubing connected to the speaker) to the user's eardrum. The bore and/or openings in the stem and/or flanges can be configured so as to selectively transmit and block desired sounds. Such selectivity can be based upon the frequency and/or intensity of the sound.

Thus, petitions, baffles, and/or restrictions (such as portions of reduced diameter), as well as openings in the stem and/or flanges, can be configured so as to modify sound transmitted through the extension in a desired manner. For example, sound within the voice range of frequencies can be selectively passed through the extension with comparatively less attenuation and sounds outside of the voice range can be selectively attenuated.

The extension can be configured so as to lack a bore. Thus, a user can wear one earpiece having an extension with a bore and one earpiece lacking a bore. The earpiece having an extension with a bore facilitates listening to a radio, while the earpiece having an extension without a bore at least partially blocks distracting and/or potentially harmful ambient sound (it functions as an earplug).

In a similar manner, one earpiece can be configured so as to selectively pass voice and to selectively mitigate other sounds. The other earpiece can be configured so as to selectively pass all of the sound from a two-way radio.

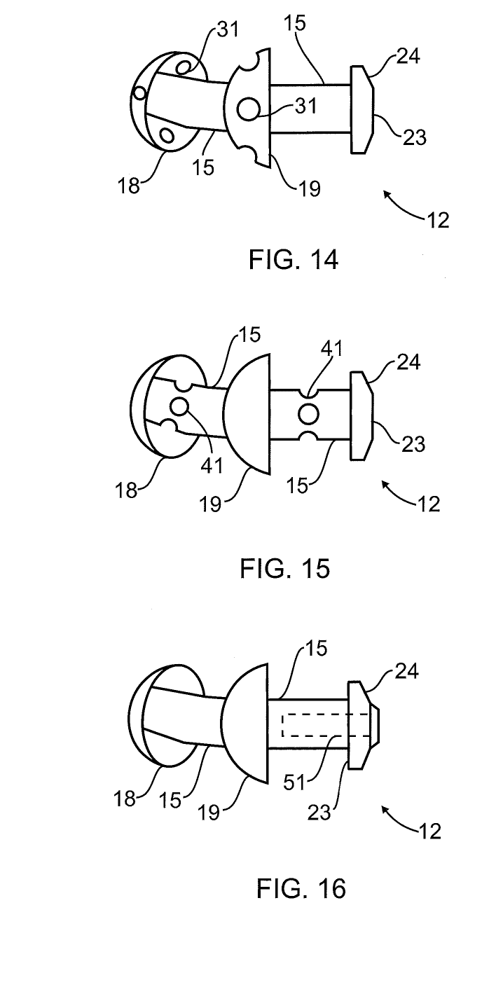

Referring now to FIG. 14, flanges 18 and 19 of extension 12 can optionally have one or more openings 31 form therein. For example, each flange, 18 and 19, can have one, two, three, or four openings 31 formed therein. Openings 31 can be holes. Alternatively, the openings 31 can be cutouts, such as notches formed in the flanges. The openings allow at least some ambient sound to better reach the user's eardrum.

Such openings 31 may be desirable when an embodiment is intended to facilitate listening to a two-way radio and when it is also desirable to hear ambient sound. For example, such openings 31 may be desirable in police applications where an officer is required to hear both the two-way radio and face-to-face conversations.

Referring now to FIG. 15, one or more openings 41 can be formed in stem 15, such as intermediate or proximate flanges, 18 and 19. Optionally, a curable polymer material suitable for use in the ear canal can be injected into the tube such that it substantially fills the tube and/or at least some space between the flanges. That is, the injected polymer material extrudes from the openings and tends to fill in the space intermediate the flanges. This injection may be accomplished with the extension inserted into a wearer's ear canal, so as to provide a custom fit. Alternatively, this injection may be performed using an artificial ear canal, such as for mass production.

The opening at the distal end of the tube can optionally be closed to prevent leakage of the injected polymer material therefrom during the injection process. Injected polymer that remains within the bore of the stem 15 can be removed.

Silicon rubber may be used as the extrudable material. Generally, any extrudable material suitable for use as earplugs can be used. In this fashion, attenuation of ambient sound is enhanced. Such earplugs/extensions are suitable for use in gun ranges and noisy industrial environments.

A skin or covering can be formed over the flanged extension to trap the polymer material during the injection process and/or to facilitate easier insertion into the ears.

Referring now to FIG. 16, a filter 51 can be inserted into bore 22 to selectively mitigate sound exposure. For example, a Hochs filter can be used to mitigate exposure to louder sounds, while still allowing a wearer to hear quieter sounds, such as speech.

Referring now to FIGS. 17 and 18, an earpiece 11 that is configured for use in the left ear is shown with the extension removed therefrom. Arcuate rib 13 and straight rib 14 define a D shape. When a mirror image arcuate rib and straight rib are configured for use in the right ear, a reverse (mirror image) D is similarly defined.

For a medium size earpiece, the height, Dimension G, can be approximately 1.087 inch and the width, Dimension H, can be approximately 0.802 inch. For a large size earpiece, the height, Dimension G, can be approximately 1.150 inch and the width, Dimension H, is approximately 0.850 inch. The medium size fits a large percentage of people.

The medium size earpiece can be configured to fit most adult ears. More particularly, the medium size earpiece can be configured to fit at least 70% of ears of men between 19 and 40 years old. Arcuate rib 13 tends to deform or bend so as to accommodate a wide range of ear sizes.

An earpiece 11 can optionally be used without an extension 12. In this instance, the thin acoustic tube 100 attaches to the earpiece 11. The thin acoustic tubing 100 can pass through the earpiece 11 and extend substantially into the ear canal. Indeed, the proximal end of the thin acoustic tube 100 can be disposed proximate the eardrum.

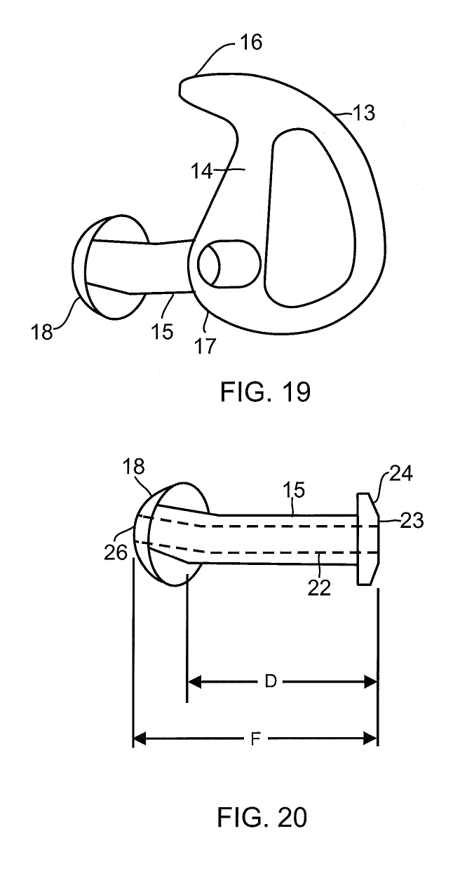

Referring now to FIGS. 19 and 20, outer flange 19 (FIG. 13) can optionally be omitted. Indeed, as mentioned above, extension 15 can comprise any desired number of flanges, including no flanges. In some instances, a single flange may perform adequately. This is particularly true when it is desirable to allow the wearer to hear ambient sound. Omitting the other flange(s) better allows ambient sound to be heard. In some applications, the primary reason for wearing the earpiece may be to allow the wearer to better hear radio communications. Positioning output port 26 close to the eardrum accomplishes this goal.

The number of flanges, as well as the configuration of the flanges, can be varied to provide a desired balance of intensity of ambient sound and sound from the radio. The configuration of the flanges can include the thickness thereof and the presence of openings therein. This balance can depend upon the environment in which the earpiece/extension is being used and can also depend upon the wearer's preference.

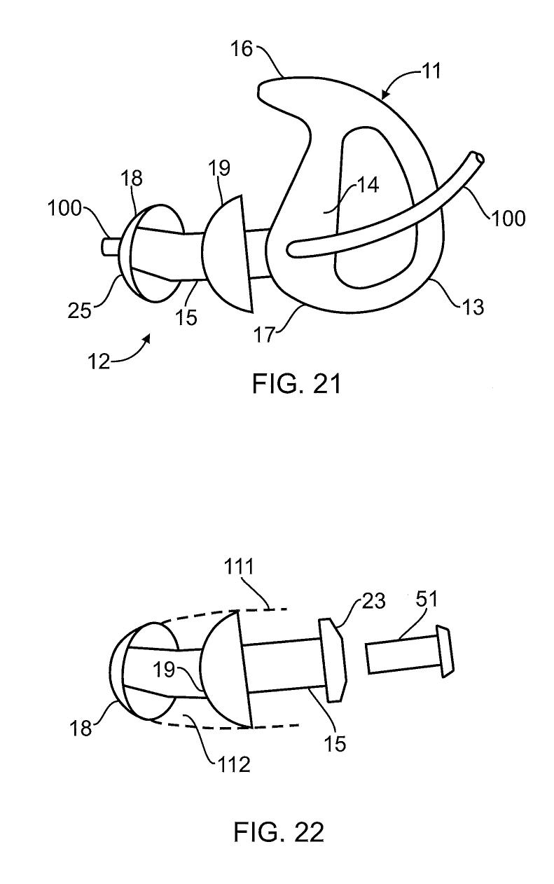

Referring now to FIG. 21, a thin acoustic tube 100 can be attached to earpiece 11 and/or extension 12 such that a generally continuous (lacking abrupt changes in diameter and lacking other restrictions or obstructions) bore is defined for sound to travel though from a speaker to the eardrum. The thin acoustic tubing can pass completely or almost completely though the extension 12. The proximal end of the thin acoustic tube 100 can be flush with or can extend from the extension 12.

The thin acoustic tube 100 can pass though the earpiece 11 and the extension 12 such that the proximal end of the thin acoustic tube 100 is disposed proximate the eardrum. Thus, the thin acoustic tube 100 can extend partially though or completely through the bore 22 of the extension 12. Indeed, the thin acoustic tube 100 can extend substantially beyond the inner end of the extension 12.

In this manner, the thin acoustic tube 100 provides a continuous passage or lumen though which sound travels from the speaker to a point proximate the eardrum. The presence of undesirable discontinuities in the lumen is mitigated. There are no abrupt changes in the diameter or the smoothness of the lumen, such as those discontinuities associated with the connection of the thin diameter tube 100 to the extension 12 via the use of a barbed fitting. The use of a barbed fitting or the like inherently results in abrupt changes in the diameter of the lumen. As those skilled in the art will appreciate, such discontinuities can adversely affect the quality of sound transmitted from the speaker to the eardrum.

Thus, the use of such a continuous lumen from the speaker to a point proximate the eardrum enhances the quality of sound from a two-radio. Such enhancement of the quality of the sound can make speech from the two-way radio more intelligible. By making speech more intelligible, the volume of the two-way radio can be turned down, thereby making its detection during covert operations less likely.

Thus, since the distal end 25 of extension 12 and/or the proximal end of thin acoustic tube 100 can be placed close to a wearer's eardrum, the volume of a two-way radio or other device (such as a cellular telephone, CD player, MP3 player, etc.) can be substantially reduced. With the volume reduced, sound advantageously cannot be as easily heard by others. During covert operations, for example, the likelihood of someone other than the wearer undesirably hearing sound from a two-way radio is substantially mitigated. By reducing the sound volume, smaller, less powerful, and/or less expensive speakers can be used. The use of a smaller speaker facilitates the making of a less conspicuous communications assembly. Placing the sound closer to the eardrum can make it easier for the hearing impaired to hear.

Embodiments (such as those embodiments having a bore 22 formed through stem 15) can be used with a variety of personal electronic devices that produce sound, including two-way radios, cellular telephones, MP3 players, CD players, cassette players, personal digital assistants (PDAs), desktop computers, laptop computers, notebook computers, pocket PCs, and hearing aids. The use of a generally smooth and continuous lumen can enhance sound quality in such applications. As those skilled in the art will appreciate, sound quality can be an important factor in music applications.

Referring now to FIG. 22, according to another embodiment extension 15 comprises one or more flanged members, 18 and 19 (similar to those of FIG. 16), having a skin or covering 111 formed thereover. Covering 111 can be formed of a thin resilient material, such as rubber (such as that which common balloons are formed of, for example). Optionally, foam or gel 112 can be disposed between the covering 111 and flanged members 18 and 19. Foam or gel 112 can comprise a biocompatible material, such as a silicon. Foam or gel 112 can extend proximal of outer flange 19, if desired. The covering 11 can be smooth and/or lubricated so as to facilitate easy insertion thereof.

Foam or gel can be injected between covering 111 and flanged members, 18 and 19, through openings 41 (FIG. 15), as discussed above. Thus, such a covering 111 can be used with extension 12 shown in FIG. 15, where an extrudable substance (which can be a foam or gel) is injected into bore 22 and passes through holes 21 to fill the void between the flanges, 18 and 19.

Thus, according to at least one embodiment the extension can comprise a tube (such as stem 15) and a rubber skin or covering, wherein foam, gel, or some other resilient substance is disposed between the tube and the rubber skin. An embodiment can optionally comprise one or more flanges. The tube can be formed of a flexible polymer material. However, the tube may alternatively be formed of a rigid polymer or metal material. The tube, foam, and skin can be attached to one another via any desired combination of friction fitting, adhesive bonding, and ultrasonic welding. The extension can be tapered to facilitate easy insertion into the ear canal and to provide a good fit therein.

One advantage of having more flanges is that the device is better secured in the ear. Another advantage of having more flanges, particularly if the flanges do not have holes formed therein, is that ambient sound is better mitigated before reaching a wearer's eardrum. Another advantage of having more flanges, particularly if the flanges do not have holes formed therein, is that the sound of the radio is better prevented from escaping from the ear, such that it may be undesirably heard by others.

Any of the flanged extensions disclosed herein can either be ambidextrous (formed to fit either the right or left ear), or can be dedicated to fit only one ear. Thus, the flanges can be either radially symmetric or can be asymmetric such that they tend to be optimized for a particular ear (left or right). They can also be optimized in configuration so as to better fit a particular person's ear.

According to one aspect, earpiece 11 is configured to fit multiple sizes of ears. More particularly, arcuate rib 13 is deformable so as to permit earpiece 11 to fit into smaller conchae bowls.

The hole 61 (FIG. 17) in earpiece 11 can be configured such that the flanged extension is positioned at the top of the ear canal, at the bottom of the ear canal, at one side of the ear canal, or is approximately centered in the ear canal. Configuring the hole such that the flanged extension is not approximately centered causes the flanged extension to be biased toward an inner surface of the ear canal and can help to keep the earpiece and extension in the ear.

However, as long as the earpiece and/or the flanges of the extension are sufficient to keep the earpiece and extension in the ear, then the flanged extension can be positioned approximately in the center of the ear canal. Positioning the flanged extension approximately in the center of the ear canal may be more comfortable for some wearers.

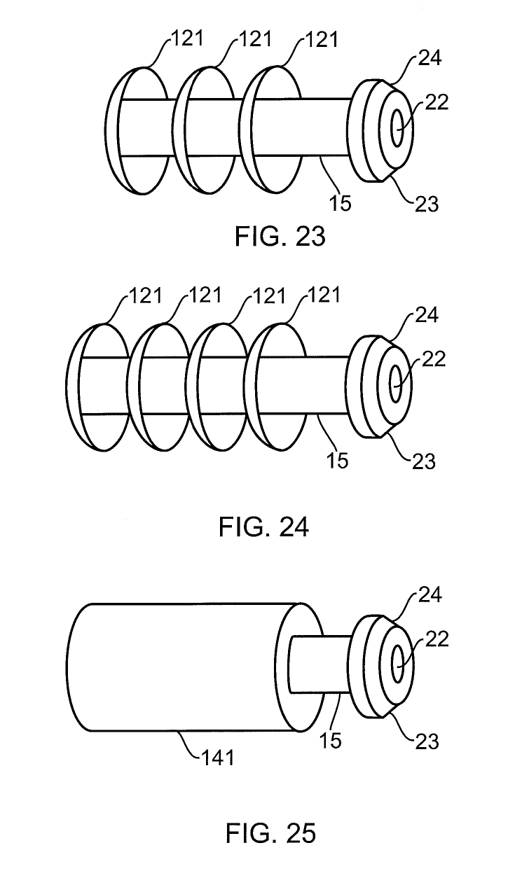

Referring now to FIG. 23, the extension can have three flanges 121 formed upon stem 15 thereof. As those skilled in the art will appreciate, the use of more flanges generally provides better sound reduction. The use of more flanges can also better secure the extension within the ear canal.

Referring now to FIG. 24, the extension can have four flanges 121 formed upon stem 15 thereof. Indeed, the extension can have any desired number of flanges formed upon stem 15 thereof.

The flanges of any embodiment can be formed integrally with the stem. Alternatively, the flanges can be formed separately from the stem and can be formed of a different material with respect thereto.

Referring now to FIG. 25, stem 15 can be covered with a resilient substance 141 such as foam, fiber, or fabric. Foam, such as a polymer foam, can be used to define a portion of the extension. The foam is compressed before or as it enters the ear canal. It then expends so as to effectively block at least a portion of the ear canal. The foam can optionally have a covering similar to that of the reusable foam ear insert of FIGS. 6-9.

In a similar manner, fiber such as cotton, can be used to define a portion of the extension. For example, cotton can cover a portion of the extension in a manner similar to the way that cotton covers the end of a Q-Tip. Cotton fiber is sufficiently compressible and resilient so as to function in a manner similar to foam.

Fabric, such as woven cotton, can similarly be used to cover a portion of the extension. Any desired combination of foam, fiber, and fabric may be used. For example, cotton fabric can be used to cover cotton fiber.

Referring now to FIG. 27, the foam, fiber, or fabric can be tapered. Tapering the resilient substance makes it conform better to the shape of the ear canal. Tapering the resilient substance can make insertion thereof into the ear canal easier.

The resilient substance of FIGS. 25-27 can be formed over stem 15, as discussed above. Alternative, the resilient substance can be attached to head 23 or the like without being formed over a stem. For example, the resilient substance can be attached to a shorter stem that does not pass substantially therethrough. As a further example, the resilient material can be attached directly to head 23 or the like.

Any desired combination of flanges, foam, fiber, and fabric can be used to at least partially block the ear canal and thereby mitigate the transmission of sound therethrough. For example, the middle flange of the extension of FIG. 23 could be replaced with a section of foam similar to the foam shown in FIG. 25.

The extension of any embodiment can be bent as shown in FIGS. 12-16 and 20-22 so as to better conform to the shape of the human ear canal. Alternatively, the extension can be straight as shown in FIG. 23-26. If the extension is straight, it can be formed of a material that is bendable, so that the extension can conform, at least somewhat, to the shape of the human ear canal when inserted therein.

Referring now to FIG. 28, that portion 171 of the extension that is inserted into the ear canal can be formed such that it does not substantially enter the ear canal. The portion 171 can be formed of a rigid material or of a resilient substance. It can also be formed by providing a resilient layer over a substantially rigid material. It need only enter the ear canal far enough so as to be effective in mitigating the level of ambient sound reaching the eardrum. Attaching this extension to an earpiece can be done to assure that it remains in place at the opening of the ear canal.

The number of flanges and/or the selection of resilient material can selectively determine the intensity and/or frequencies of ambient sound that is transmitted thereto to a wearer's eardrum. Thus, control over the ambient sound that is heard can be achieved. Desirable, lower intensity sounds can be readily transmitted to the eardrum, while harmful, higher intensity sounds are attenuated.

Thus, one or more embodiments can mitigate noise exposure and/or facilitate communications. Noise exposure is mitigated by at least partially blocking the ear canal with an extension from an earpiece. Communications are facilitated by providing a passage for sound through an earpiece extension or ear insert. The extension or insert and/or the thin acoustic tubing that passes therethrough can extend to a point proximate the eardrum, so that sound is delivered more directly to the eardrum. Thus, less volume is needed. The use of less volume is useful in covert operations. As stated above, it may also facilitate the use of smaller, less powerful, and/or less expensive speakers.

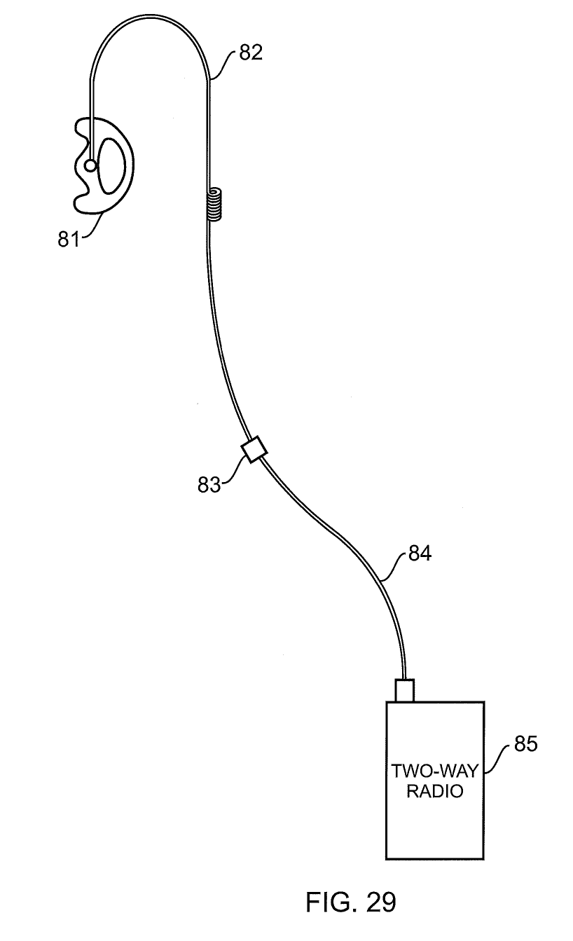

Referring now to FIG. 29, a two-way radio system can comprise an earpiece 81 to which is attached a thin acoustic tube 82. The thin acoustic tube 82 can be substantially longer than that shown in FIGS. 1-7, 10 and 11. The use of a longer thin acoustic tube 82 can better facilitate enhanced flexibility with respect to positioning of speaker 83. Thus, speaker 83 can be disposed beneath the clothes instead of behind the ear, for example. Speaker 83 is in electrical communication with a two-way 85 radio or the like via cable 84.

As described above, an inconspicuous communications assembly can comprise thin acoustic tubing and an earpiece/extension or an ear insert. In this manner, the likelihood of undesirable discovery of the communications assembly during a covert operation is mitigated.

Embodiments described above illustrate, but do not limit, the invention. It should also be understood that numerous modifications and variations are possible in accordance with the principles of the present invention. Accordingly, the scope of the invention is defined only by the following claims.

1. A communications assembly comprising:
an earpiece configured to be captured within a wearer's conchae;
an extension attached to the earpiece and configured to be inserted into the wearer's ear canal; and
a thin acoustic tube configured to communicate sound to the earpiece.

2. The communications assembly as recited in claim 1, further comprising a speaker attached to the acoustic tube so as to communicate sound therethrough.

3. The communications assembly as recited in claim 1, further comprising
a speaker attached to the acoustic tube so as to communicate sound therethrough;
an amplifier in electrical communication with the speaker;
a microphone in electrical communication with the amplifier; and
wherein the microphone is configured to pick up ambient sound and the amplifier is configured to amplify ambient sound and provide an electrical signal representative thereof to the speaker.

4. The communications assembly as recited in claim 1, further comprising:
a speaker attached to the acoustic tube so as to communicate sound therethrough; and
a two way radio in electrical communication with the speaker.

5. The communications assembly as recited in claim 1, wherein the extension comprises at least one flange.

6. The communications assembly as recited in claim 1, wherein the extension comprises two flanges.

7. The communications assembly as recited in claim 1, wherein the extension comprises three flanges.

8. The communications assembly as recited in claim 1, wherein the thin acoustic tubing has an outer diameter of between approximately 0.8 mm and approximately 1.4 mm.

9. The communications assembly as recited in claim 1, wherein the thin acoustic tubing has an outer diameter of approximately 1.0 mm.

10. The communications assembly as recited in claim 1, wherein the acoustic tubing is clear.

11. The communications assembly as recited in claim 1, wherein the acoustic tubing is flesh colored.

12. The communications assembly as recited in claim 1, wherein the thin acoustic tubing is long enough to facilitate hiding of a speaker attached to the distal end thereof beneath a wearer's clothing.

13. A communications assembly comprising:
an ear insert configured to be inserted into the wearer's ear canal; and
a thin acoustic tube configured to communicate sound to the ear insert.

14. The communications assembly as recited in claim 13, wherein the ear insert comprises foam.

15. The communications assembly as recited in claim 13, wherein the ear insert comprises:
a foam body; and
a non-foam covering formed upon the foam.

16. The communications assembly as recited in claim 13, wherein the ear insert comprises:
a foam rubber body; and
a vinyl covering formed upon the foam body.

17. The communications assembly as recited in claim 13, wherein the thin acoustic tubing is long enough to facilitate hiding of a speaker attached to the distal end thereof beneath a wearer's clothing.

18. A two-way radio system comprising:
a two way radio;
a speaker in electrical communication with the two-way radio;
a thin acoustic tube in acoustic communication with the speaker;
an earpiece to which the acoustic tube is attached; and
an extension attached to the earpiece and configured to be inserted into the wearer's ear canal.

19. The two-way radio system as recited in claim 18, wherein the extension comprises at least one flange.

20. The two-way radio system as recited in claim 18, wherein the acoustic tubing is clear.

21. The two-way radio system as recited in claim 18, wherein the acoustic tubing is flesh colored.

22. A two-way radio system comprising:
a two-way radio;
a speaker in electrical communication with the two-way radio;
a thin acoustic tube configured to communicate sound from the speaker to the earpiece; and
an ear insert configured to be inserted into the wearer's ear canal, the ear insert being in acoustic communication with the thin acoustic tubing.

23. The two-way radio system as recited in claim 22, wherein the ear insert comprises foam.

24. The two-way radio system as recited in claim 22, wherein the ear insert comprises:
a foam body; and
a non-foam covering formed upon the foam.

25. The two-way radio system as recited in claim 22, wherein the ear insert comprises:
a foam rubber body; and
a vinyl covering formed upon the foam body.

26. A communications assembly comprising:
an ear insert configured to be inserted into the wearer's ear canal; and
a thin acoustic tube passing completely through the ear insert so as to provide a generally continuous lumen from a speaker to a point proximate an eardrum.

27. A communications assembly comprising:
an earpiece configured to be captured within a wearer's conchae;
an extension attached to the earpiece and configured to be inserted into the wearer's ear canal; and
a thin acoustic tube passing completely through the extension so as to provide a generally continuous lumen from a speaker to a point proximate an eardrum.
